(19) United States
(12) Patent Application Publication
(10) Pub. No.: US 2005/0111408 A1
(43) Pub. Date: May 26, 2005

(54) Selective interference cancellation

(75) Inventors: Per Skillermark, Stockholm (SE); Tomas Sundin, Uppsala (SE)

Correspondence Address: NIXON & VANDERHYE, PC, 1100 N GLEBE ROAD, 8TH FLOOR, ARLINGTON, VA, 22201-4714, US

(73) Assignee: Telefonaktiebolaget LM Ericsson (publ), Stockholm (SE)

(21) Appl. No.: 10/720,691

(22) Filed: Nov. 25, 2003

(51) Int. Cl. H04Q 7/00

(52) U.S. Cl. 370/331; 370/441

(57) ABSTRACT

A mobile station for a TD—CDMA cellular system includes means for maintaining a list of intracell interferers to the mobile station. Further means (14, 16) detect intercell interferers to the mobile station by using handover related information available in the mobile station. Detected intercell interferers that fulfil a predetermined selection criterion are added to the list of interferers. Means (12) are provided for performing interference cancellation for all interferers, both intracell and intercell, in the list with a joint detection algorithm.

### TECHNICAL FIELD

The present invention relates generally to selective interference cancellation (IC) in CDMA (Code Division Multiple Access) cellular systems, and especially in TD—CDMA (Time Division—Code Division Multiple Access) cellular systems.

### BACKGROUND

In CDMA cellular systems different channels are distinguished by long channelization and scrambling codes. In the downlink, channelization codes are often used to separate users within one radio cell, while scrambling codes are used to distinguish channels of different cells. Since different channelization codes are orthogonal, there is ideally no downlink interference between different channels in one radio cell. However, in a time dispersive radio propagation channel, downlink own-cell or intracell interference is introduced. In addition to the intracell interference, the downlink signal is interfered by signals from other cells, so called other-cell or intercell interference. In order to efficiently suppress the intercell interference, the used scrambling codes must be relatively long.

In the upcoming TDD (Time Division Duplex) TD—CDMA cellular systems, like the 1.28 and 3.84 Mcps (Mega Chips Per Second) UTRA TDD (UTRA=UMTS Terrestrial Telecommunication System, UMTS=Universal Mobile Telecommunication System), however, the used channelization and scrambling codes are relatively short. Because of the short scrambling codes, the intercell interference suppression capability is limited. However, the short codes in combination with the employed TDMA scheme, which limits the number of simultaneous users, also facilitates the use of complex receiver algorithms that jointly detect several channels in the received signal. Since some a priori information of the signals in the detection set is required, such joint detection (JD) algorithms typically limit the signals in the detection set to intracell interferers. Hence, such JD algorithms are typically used to suppress intracell interference while the intercell interference and the effects thereof is unaltered.

In general the downlink intercell interference in a TDD TD—CDMA cellular system originates either from a base station in a neighboring cell or from a mobile station in a neighboring cell. In contrast, the downlink intercell interference in an FDD CDMA system always originates from a neighboring base station. Base station originated intercell interference is fairly predictable but may still cause considerable impact due to its strength. Mobile station originated intercell interference, on the other hand, is unpredictable Such interference typically occurs with low probability, but due to near-far-effects (in a power controlled system, a mobile station transmits at high power when far from the own base station and at low power when close to the own base station—furthermore, the interfered mobile may be close or far away from the interfering mobile station), the strength and the impact of the interference may be considerable for the affected mobile.

One way to avoid the unpredictable MS originated intercell interference in TDD TD—CDMA cellular systems is to coordinate neighboring cells. Then, since all cells use the same uplink and downlink allocation, the interference situation is identical to that of a FDD system. In the downlink this means that all interference originates from neighboring base stations. A drawback of this approach, however, is that the uplink-downlink flexibility in a radio cell is seriously limited. When coordinating neighboring cells, individual cells cannot allocate resources according to the local uplink-downlink traffic demand. Instead, the resource allocation must be based on some measure of the overall system traffic demand.

A well-known way to limit the intercell interference is to introduce a reuse scheme, either in the frequency or in the time domain. A reuse scheme increases the distance between interfering and interfered units. The disadvantage is that it reduces the amount of resources (channels) available in each cell, which increases the blocking probability. Another way to handle the interference is to introduce advanced receivers that can operate also in the presence of high interference. The cost in this case is an increased receiver complexity.

In [1], a selective uplink interference canceling (IC) method is proposed with the purpose to facilitate hard handover in CDMA systems. In [1], the MS measures the signal strength of its serving and its neighboring BSs, and these measurements are signaled to the network. If the difference in signal strength between the serving BS and one of the neighboring BSs is below a predetermined threshold value, the MS is considered to be close to this neighbor BS and considered as a potential interferer to that cell. The network then informs the neighboring BS about this potentially interfering MS and the neighboring BS may use interference cancellation to suppress the interference originating from this particular MS. A drawback of the method proposed in [1] is that it requires additional signaling in both the radio network and in the fixed network. Furthermore, the method is applicable only in the uplink.

Document [2] describes an intracell IC method in which intracell interferers exceeding a certain received power level are included in a JD algorithm of an MS.

Document [3] describes an IC method in which an MS connected to a non-optimal base station cancels interference caused by other base stations. No selection procedure is described.

Document [4] describes an uplink IC method in which a signal received by a BS is decoded either by using a JD algorithm or conventional decoding, depending on the quality of the signal and the strength of interfering signals.

### SUMMARY

A general object of the present invention is to increase the performance of a CDMA cellular system, especially TD—CDMA cellular systems, without requiring any changes to standard specifications or requiring additional signaling in the radio network.

This object is achieved in accordance with the attached claims.

Briefly, the present invention offers selective interference cancellation for critical scenarios in CDMA based cellular systems, such as the upcoming 1.28 and 3.84 Mcps UTRA TDD standards. The critical scenarios are identified as users at the cell boundary close to making a handover. The additional information about the interferers available for these users can be used to examine if interference cancellation is required and, if so, to include these interferers in an existing JD algorithm.

### BRIEF DESCRIPTION OF THE DRAWINGS

The invention, together with further objects and advantages thereof, may best be understood by making reference to the following description taken together with the accompanying drawings, in which:

FIG. 1 is a flow chart illustrating an exemplary embodiment of the interference cancellation method in accordance with the present invention; and

FIG. 2 is a block diagram illustrating an exemplary embodiment of an interference cancellation arrangement in a mobile station in accordance with the present invention.

### DETAILED DESCRIPTION

In the following description the terms mobile station (MS), user equipment (UE) and user will be used interchangeably.

Interference cancellation (IC) is often used to remove interference from other sources than the intended. One approach is to model interference as individual users with known spreading and scrambling codes. The algorithms are based on estimation of the interfering users one by one (in parallel (PIC) or in sequence (SIC)). The estimates are used to reconstruct the user signals. The reconstructed signals are then subtracted from the received signal and the detection is repeated a number of times until a certain stopping criterion is reached. Another approach is to jointly detect all users in the received signal (methods known as joint detection (JD) or multi user detection (MUD)). These methods give superior performance compared to the first mentioned approach, since the cross correlation between all users can be considered in the detection process. The drawback is that these methods are very computationally complex and normally only can be applied if there are a limited number of users in the cell.

In UTRA TDD cellular systems, the intercell interference is a limiting factor of the downlink performance. Since the intercell interference increases as a user moves closer to neighboring cells, it is especially users at the cell boundary that are affected by the intercell interference. Furthermore, since these users are located far from the own base station, there is also a high pathloss between the base station and the user. Both circumstances have a negative impact on performance. In a power-controlled system, because of the high pathloss and high intercell interference experienced, users at the cell border consume a large amount of power and thereby also create a large amount of interference. In non-power-controlled systems, typically using scheduling and link adaptation on a downlink shared channel, these users will experience low bitrates. A low bitrate (negatively) affects the quality of service perceived by the user. Furthermore, such a user needs much time to complete the data transmission, which degrades the system performance.

In both cases (power-controlled and non-power controlled systems), it is of interest to improve the performance for users at the cell border since this will enhance the overall system performance. Therefore, it is of special interest to introduce an IC algorithm particularly suited for users located near or at the cell boundary.

The solution is based on the insight that the users close to the cell boundaries are also close to doing a handover. Therefore these users are in a position to be able to listen to the traffic in the neighboring cell(s) and thereby acquire all the information necessary to include the intercell interferers in the JD algorithm. Compared to the standard IC algorithms JD is much more efficient due to the use of the information about the spreading codes and scrambling codes of the interferers. Since a JD is already in use for elimination of intracell interference, it is simple to include also the intercell interferers. Furthermore, it is possible to selectively choose which interferers to include in the JD depending on the power and correlation characteristics of the interferers. This makes it possible to keep the computational load to a minimum. In summary, the IC is selective in two ways; first, only users at the cell boundary close to making a handover should use the IC; second, only interferers with high power and high correlation with the users own codes should be included in the JD.

In 3.84 (and 1.28) Mcps UTRA TDD there exists only hard handover. The decision to make a hard handover is taken by UTRAN (UMTS Terrestrial Radio Access Network) based on measurements performed by the user equipment (UE). The UE is ordered by UTRAN to measure the received signal code power (RSCP) for a number of possible cells. The UE performs a cell search by first listening to the synchronization channel (SCH). The information on the SCH gives information of a set of possible scrambling codes and basic midamble codes as well as information on where to find the primary common control physical channel (P-CCPCH). From the P-CCPCH the UE obtains the actual scrambling code and basic midamble sequence. Finally, the RSCP is measured on the P-CCPCH and reported to UTRAN.

The decision to use the selective IC should be based on the interfering signal power. If the interfering signal power is within a predetermined window relative to the own signal power or if the absolute level of the interfering signal power exceeds a predetermined threshold, then the selective IC algorithm should be used. The selective IC is performed in all timeslots where the UE receives data. Since the scrambling code and midamble sequence used in the neighboring cell can be obtained from the handover measurement procedure, the only thing that has to be added is an additional channel estimation procedure. This procedure involves estimating the downlink channels and determining the active channelization codes. After determining the channelization codes the cross-correlation between the interference code(s) and the user code(s) (taking the channel realization into account) can be examined. If this cross-correlation is strong enough then the intercell interferer code(s) is/are included in the same JD algorithm that is used to handle the intracell interference.

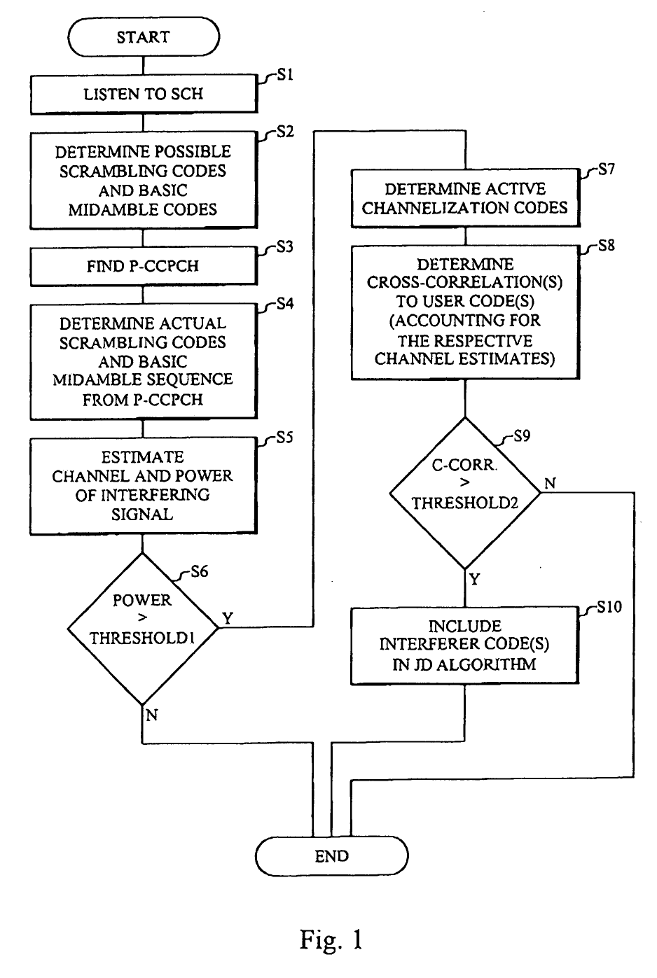

FIG. 1 is a flow chart illustrating an exemplary embodiment of the interference cancellation method in accordance with the present invention. For the handover preparation the MS receives from the UTRAN a list of cells, which the MS shall monitor in its idle timeslots. The following procedure is performed for each cell in the list using the same frequency band as the mobile station. In step S1 the MS listens to the SCH of the cell (each cell has one SCH). From each SCH the MS finds possible scrambling and basic midamble codes of the cell (step S2). In step S3 the MS finds the P-CCPCH from the SCH. Step S4 determines the actual scrambling codes and midamble sequence from the P-CCPCH.

As an illustration, the cell search procedure S1-S4 will be briefly described for the 3.84 Mcps UTRA TDD. The procedure is also described in [5]. During the cell search, the MS searches for a cell and determines the downlink scrambling code, basic midamble code and frame synchronization of that cell. The cell search is typically carried out in three phases.

During the first phase of the cell search procedure the MS uses the SCH's primary synchronization code to find a cell. This is typically done with a single matched filter (or any similar device) matched to the primary synchronization code which is common to all cells. A cell can be found by detecting peaks in the matched filter output.

During the second phase of the cell search procedure, the MS uses the SCH's secondary synchronization codes to identify 1 out of 32 code groups for the cell found in the first step. This is typically done by correlating the received signal with the secondary synchronization codes at the detected peak positions of the first phase. The primary synchronization code provides the phase reference for coherent detection of the secondary synchronization codes. The code group can then uniquely be identified by detection of the maximum correlation values. Each code group indicates a different t_{offset} parameter and 4 specific cell parameters. Each of the cell parameters is associated with one particular downlink scrambling code and one particular long and short basic midamble code. When the MS has determined the code group, it can unambiguously derive the slot timing of the found cell from the detected peak position in the first phase and the t_{offset} parameter of the found code group in the second phase.

During the third and last phase of the cell search procedure, the MS determines the exact downlink scrambling code, basic midamble code and frame timing used by the found cell. The long basic midamble code can be identified by correlation over the P-CCPCH with the 4 possible long basic midamble codes of the code group found in the second step. A P-CCPCH always uses a midamble derived from the long basic midamble code and always uses a fixed and pre-assigned channelization code. When the long basic midamble code has been identified, the downlink scrambling code and cell parameter are also known.

A corresponding search procedure for 1.28 Mcps UTRA TDD is described in [6].

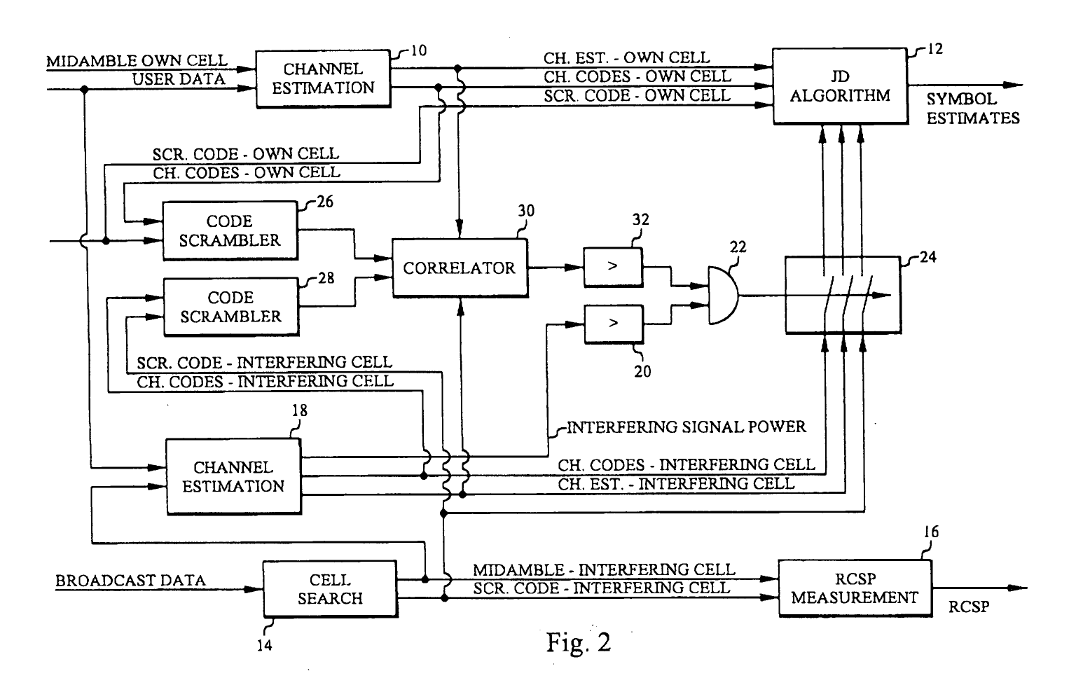

Returning to FIG. 1, step S5 estimates the interfering channels and interfering signal power of the cell. Step S6 determines whether the measured interfering signal power exceeds a first threshold. If not, the interference is considered to be acceptable and no interferers from this cell are included in the JD algorithm. If the interfering signal power exceeds the threshold, step S7 determines the channelization codes of interfering channels of the cell. Step S8 determines the cross-correlation between these channelization codes and channelization codes used by the MS (actually the cross-correlation between scrambled codes with proper account taken for the influence of the differing channels, as described with reference to FIG. 2). Step S9 tests whether the cross-correlations exceed a second threshold. For each cross-correlation that exceeds the second threshold the corresponding interferer channelization code is included in the JD algorithm in step S10. Steps S7-S10 are performed for all interfering channels that fulfill the condition in step S6.

In summary, the preferred embodiment of the selective IC method in accordance with the present invention identifies intercell interferers that use the same frequency band as the MS, have a sufficiently high power level and use a scrambling/channelization code combination that has a sufficiently high cross-correlation to the scrambling/channelization code combination(s) used by the MS (after accounting for the influence of the respective channels). Interferers fulfilling these criteria are added to the JD algorithm.

FIG. 2 is a block diagram illustrating an exemplary embodiment of an interference cancellation arrangement in a mobile station in accordance with the present invention. In order to facilitate the description, only elements necessary to explain the interference cancellation have been included in the figure.

The upper part of FIG. 2 describes the symbol detector with the channel estimation 10 and JD algorithm 12. The input to these modules consists of the user data, the cell specific scrambling code and the midamble codes. The output is the estimated symbols.

The lower part of the FIG. 2 describes the cell search and RCSP measurement blocks 14, 16 that are activated upon orders from the UTRAN. The input to this module is the broadcast data in the SCH and the P-CCPCH of each interfering cell (potential handover cell) in the list received from the UTRAN.

In the middle part of the figure, the new features of the selective IC are illustrated. There is provided a channel estimation module 18 that requires the user data and the midamble sequence that was determined during the handover measurements as input. The JD of the symbol detector 12 can be used as before but with the additional input of the channel estimates, channelization codes and scrambling code of the interfering cell. In this way the JD algorithm may be used for both intracell and inercell interferers.

The arrangement in FIG. 2 described so far would include all intercell interferers, which would lead to a very complex JD algorithm. In accordance with the present invention there are further restrictions that may be used to limit the number of intercell interferers to a manageable number. The most important parameter to consider is the interfering signal power of interfering cells using the same frequency band as the MS. In accordance with a preferred embodiment of the present invention, the detected interfering signal power level, which is obtained from the channel estimation in block 18, is forwarded to a comparator 20. There it is compared to a predetermined power level or first threshold. This threshold may, for example, have a value of 5-15 dB below the power level of the signal of interest. If the detected interfering signal power level exceeds this threshold a logical “1” is forwarded to an AND gate 22. The output of AND gate 22 controls a switch 24 in such a way that the channel estimates, channelization codes and scrambling code of the interfering cell are forwarded to JD algorithm 12 only if the detected interfering signal power level exceeds the first threshold. In this way only the intercell interferers with sufficiently high power levels are included in the JD algorithm. The number of included intercell interferers may be controlled by setting the threshold to a suitable value.

The selection of interferers based on interfering signal power level described in the previous paragraph includes all interferers of an interfering cell in the JD algorithm if the interfering signal power level exceeds the first threshold. A further restriction that may be imposed on the intercell interferers before they are added to the JD algorithm is to include only interfering signals that are strongly correlated to the user signal of interest. In the embodiment illustrated in FIG. 2 this restriction is implemented by forwarding the scrambling and channelization codes of the own cell of the MS to a code scrambler 26 and the scrambling and channelization codes of the potential handover or interfering cell to a code scrambler 28. These code scramblers perform a bitwise multiplication of the respective channelization codes by the corresponding scrambling codes (assuming that logical “0” and “1” have been mapped to 1 and −1). The resulting spreading codes of the own and interfering cell are then subjected the influence of their respective channels by using the channel estimates from blocks 10 and 18, and thereafter correlated in a correlator 30. If the cross-correlation exceeds a predetermined cross-correlation level or second threshold, a logical “1” is forwarded to the second input terminal of AND gate 22. This will activate switch 24 to forward the channel estimate, channelization code and scrambling code associated with this interfering channel to JD algorithm 12 if the detected interfering signal power level also exceeds the first threshold. The same procedure is performed for all channels of potential intercell interferers.

Thus, in the preferred embodiment of the IC procedure of the present invention, both the interfering signal power level and spreading code cross-correlation are used to restrict the number of intercell interferers to include in the JD algorithm. The complexity of the JD algorithm can be controlled by setting the thresholds to values that keep the number of intercell interferers at a reasonable level. For example, typically there are 16 channelization codes per cell. In this case there are a maximum of 15 intracell interferers. By setting the thresholds to appropriate values, about the same number of intercell interferers may be included in the JD algorithm without too much burden on the MS.

Although the described combined restriction criterion is preferred, it is also feasible to base the restriction on only one of these parameters (interfering signal power level, spreading code cross-correlation). If only one parameter is used, the restriction is preferably based on the measured interfering signal power level. Another possibility is to rank the intercell interferers and only include up to a maximum number of interferers in the JD algorithm.

The functionality of the various blocks in FIG. 2 are typically implemented by a micro processor or a micro/signal processor combination and corresponding software.

From the description above it is clear that the selective IC in accordance with the present invention does not require substantial changes in the existing symbol detector procedures.

Furthermore, as the same cell specific scrambling code is used in both uplink and downlink the method is applicable in both coordinated and uncoordinated scenarios. To the JD receiver it is irrelevant whether the intercell interference originates from a BS or an MS.

An essential advantage of the proposed selective interference cancellation technique is that it may be introduced in the mobiles without any specification changes (it is transparent to the network). The positive impact on system performance will, however, increase with the penetration of the mobiles supporting the proposed selective IC scheme. No additional signaling is required in the radio network.

Although the present invention has been described with reference to TD—CDMA cellular systems in accordance with certain standards, it is appreciated that the same principles may be used in CDMA systems in general (both TDD and FDD, i.e. system in which the uplink and downlink are separated either in time or in frequency).

It will be understood by those skilled in the art that various modifications and changes may be made to the present invention without departure from the scope thereof, which is defined by the appended claims.

### REFERENCES

[1] U.S. Pat. No. 5,862,124, Hottinen et al (Nokia Telecommunications OY), “Method for Interference Cancellation in a Cellular CDMA Network”.

[2] U.S. 2002/0181557 A1, Hideo Fujii, “Communication Terminal Apparatus and Demodulation Method”.

[3] U.S. Pat. No. 5,740,208, Hulbert et. al. (Roke Manor Research Limited), “Interference Cancellation Apparatus for Mitigating the Effects of Poor Affiliation Between a Base Station and a Mobile Unit”.

[4] WO 01/45289 A1, ERICSSON INC, “Selective Joint Demodulation Systems and Methods for Receiving a Signal in the Presence of Noise and Interference”.

[5] 3GPP TS 25.224: “Physical layer procedures (TDD)”, Annex C

[6] 3GPP TS 25.224: “Physical layer procedures (TDD)”, Annex CA

1. An interference cancellation method for a mobile station in a radio cell of a CDMA cellular system, including the steps of
maintaining a list of intracell interferers to the mobile station;
detecting intercell interferers to the mobile station;
adding each detected intercell interferer that fulfils a predetermined selection criterion to said list; and
performing, based on information about the interferers in said list, interference cancellation for all interferers in said list.

2. The method of claim 1, including the step of using handover related information available in the mobile station for detecting intercell interferers.

3. The method of claim 1, including the steps of
measuring received interfering signal power from intercell interferers using the same frequency band as the mobile station;
adding to said list only intercell interferers having a measured received interfering signal power that exceeds a predetermined power level.

4. The method of claim 1, including the steps of
determining the cross-correlation between a desired signal and signals from intercell interferers;
adding to said list only intercell interferers having a determined cross-correlation that exceeds a predetermined cross-correlation level.

5. The method of claim 1, including the following steps for each intercell interferer to be included in said list:
determining a channel estimate;
determining a channelization code;
determining a scrambling code;
forwarding the determined channel estimate, channelization code and scrambling code to a joint detection algorithm used by all interferers in said list.

6. An interference cancellation apparatus for a mobile station in a radio cell of a CDMA cellular system, including
means for maintaining a list of intracell interferers to the mobile station;
means for detecting intercell interferers to the mobile station;
means for adding each detected intercell interferer that fulfils a predetermined selection criterion to said list; and
means for performing, based on information about the interferers in said list, interference cancellation for all interferers in said list.

7. The apparatus of claim 6, including means for using handover related information available in the mobile station for detecting intercell interferers.

8. The apparatus of claim 6, including
means for received interfering signal power from intercell interferers using the same frequency band as the mobile station;
means for adding to said list only intercell interferers having a measured received interfering signal power that exceeds a predetermined power level.

9. The apparatus of claim 6, including the steps of
means for determining the cross-correlation between a desired signal and signals from intercell interferers;
means for adding to said list only intercell interferers having a determined cross-correlation that exceeds a predetermined cross-correlation level.

10. The apparatus of claim 6, including the following steps for each intercell interferer to be included in said list:
determining a channel estimate;
determining a channelization code;
determining a scrambling code;
forwarding the determined channel estimate, channelization code and scrambling code to a joint detection algorithm used by all interferers in said list.

11. A mobile station for a CDMA cellular system, including
means for maintaining a list of intracell interferers to the mobile station;
means for detecting intercell interferers to the mobile station;
means for adding each detected intercell interferer that fulfils a predetermined selection criterion to said list; and
means for performing, based on information about the interferers in said list, interference cancellation for all interferers in said list.

12. The mobile station of claim 11, including means for using handover related information available in the mobile station for detecting intercell interferers.

13. The mobile station of claim 10, including
means for measuring received interfering signal power from intercell interferers using the same frequency band as the mobile station;
means for adding to said list only intercell interferers having a measured received interfering signal power that exceeds a predetermined power level.

14. The mobile station of claim 10, including the steps of
means for determining the cross-correlation between a desired signal and signals from intercell interferers;
means for adding to said list only intercell interferers having a determined cross-correlation that exceeds a predetermined cross-correlation level.

15. The mobile station of claim 10, including the following steps for each intercell interferer to be included in said list:
determining a channel estimate;
determining a channelization code;
determining a scrambling code;
forwarding the determined channel estimate, channelization code and scrambling code to a joint detection algorithm used by all interferers in said list.
